(19) United States
(12) Patent Application Publication
(10) Pub. No.: US 2013/0079162 A1
(43) Pub. Date: Mar. 28, 2013

(54) DEVICE FOR USE AS A TORSIONAL VIBRATION DAMPER OR AS AN UNCOUPLED PULLEY

(71) Applicants: Arndt Rodenbach, Breisach (DE); Patrick Capelle, Staufen (DE)

(72) Inventors: Arndt Rodenbach, Breisach (DE); Patrick Capelle, Staufen (DE)

(73) Assignee: CARL FREUDENBERG KG, Weinheim (DE)

(21) Appl. No.: 13/614,107

(22) Filed: Sep. 13, 2012

(30) Foreign Application Priority Data
Sep. 28, 2011 (DE) 10 2011 114 447.5

(51) Int. Cl. F16F 15/26; F16D 3/76; F16D 3/12

(52) U.S. Cl. 464/92; 188/379

(57) ABSTRACT

A device configured to be arranged on a crankshaft includes a base having a hub journal, the hub journal extending in an axial direction and having a centered opening configured to receive a mounting screw. A hub rim surrounds the hub journal. An inertia ring encircles the hub rim and is connected to the hub rim via an elastomer. At least one of the hub rim and the hub journal is fitted with a support device configured to provide support against a torque. The support device includes elements that project in a pin-like manner from the at least one of the hub rim and the hub journal in the axial direction.

### CROSS-REFERENCE TO PRIOR APPLICATION

Priority is claimed to German Patent Application No. DE 10 2011 114 447.5, filed on Sep. 28, 2011, the entire disclosure of which is hereby incorporated by reference herein.

### FIELD

The invention relates to a device to be arranged on a crankshaft, comprising a base having a hub journal, a hub rim surrounding the hub journal, and an inertia ring, whereby the inertia ring is connected to the hub rim by means of an elastomer and encircles it, whereby the hub journal extends in the axial direction and has a centered opening to receive a mounting screw, and whereby the hub rim or from the hub journal is fitted with means to provide support against a torque.

### BACKGROUND

Torsional vibration dampers are known from the state of the art in which the hub rim and the hub journal are made in one piece of a cast material. The torsional vibration damper is normally screwed to a crankshaft by means of a mounting screw.

For this purpose, the hub journal has a centered opening through which the mounting screw is inserted and screwed to the crankshaft. When the mounting screw is being tightened, it is necessary to support the torsional vibration damper against a torque. Otherwise, the torsional vibration damper would be picked up by the rotation of the mounting screw and be turned along with it.

It is a known procedure from the state of the art to provide the hub journal or the hub rim with means to provide support against a torque. In particular, it is a known procedure to cast the hub rim or from the hub journal in such a way that a socket is formed on the hub rim.

This socket has an inner circumferential surface that creates a hexagonal shape. In this manner, a hexagon wrench can be inserted into the socket and can support the torsional vibration damper against a torque that is generated when the mounting screw is being tightened.

The socket can also have an outer circumferential surface that likewise describes a hexagonal geometry. In this version, the socket can be inserted into the interior of the hexagon wrench.

### SUMMARY

In an embodiment, the present invention provides a device configured to be arranged on a crankshaft. The device includes a base having a hub journal, the hub journal extending in an axial direction and having a centered opening configured to receive a mounting screw. A hub rim surrounds the hub journal. An inertia ring encircles the hub rim and is connected to the huh rim via an elastomer. At least one of the hub rim and the hub journal is fitted with a support device configured to provide support against a torque. The support device includes elements that project in a pin-like manner from the at least one of the hub rim and the hub journal in the axial direction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a torsional vibration damper according to the state of the art, whereby the hub rim and the hub journal are configured in one piece as a cast part,

FIG. 2 shows a torsional vibration damper according to an embodiment of the invention, in which a support device is configured as elements that project like pins,

FIG. 3 shows an uncoupled pulley according to the state of the art, whereby the hub rim and the hub journal are configured in one piece as a cast part, and

FIG. 4 shows an uncoupled pulley according to the invention, in which a support device is configured as elements that project like pins.

### DETAILED DESCRIPTION

The production of hub journals or hub rims that are provided with an inner or outer polygon geometry is extremely laborious and expensive. The cast materials and casting methods needed for this entail high costs.

In an embodiment, the present invention provides an inexpensive solution namely, to mount a device, especially a torsional vibration damper, onto the end of a crankshaft.

In an embodiment, the invention is based on the objective of configuring and refining a device in such a way that, after being manufactured inexpensively, it can be mounted onto the end of a crankshaft without any problems.

A device according to an embodiment of the invention to be arranged on a crankshaft comprises a base having a hub journal, a hub rim surrounding said hub journal, and an inertia ring, whereby the inertia ring is connected to the hub rim by means of an elastomer and encircles it, whereby the hub journal extends in the axial direction and has a centered opening to receive a mounting screw, and whereby the hub rim or from the hub journal is fitted with a support device to provide support against a torque.

According to an embodiment of the invention, it is provided that the support device is configured as elements that project like pins from the hub rim or from the hub journal in the axial direction.

According to an embodiment of the invention, it was first realized that the pin-like elements are sufficiently sturdy to provide support against a torque. A mounting tool or a dolly block can fit positively into a structure formed by the pin-like elements and can withstand the threes and torques generated when the mounting screw is being tightened. According to an embodiment of the invention, it has also been recognized that pin-like elements allow the hub journal and the hub rim to be made of different materials. Finally, it has been recognized that pin-like elements occupy very little space and thus yield compact devices. Hence, a device is put forward that, after being manufactured inexpensively, can be secured onto the end of a crankshaft without any problems.

Consequently, the above-mentioned objective is achieve

An embodiment of the invention especially relates to devices that are configured as uncoupled pulleys or torsional vibration dampers.

The huh journal and the hub rim could be configured as separately manufactured parts. Owing to this concrete configuration, the hub journal could be made, for example, as a cast part, and the hub rim could be made as a sheet metal part. The separate production makes it possible to treat the hub journal with a grinding disk or other tools in such a way that a sealing contact face can be formed on it. The sealing contact face can be treated in such a way that a ring, preferably a polytetrafluoroethylene ring, can slide on the sealing contact face so as to create a seal.

The hub journal could be screwed to the hub rim, Advantageously and surprisingly, a screwed connection is sufficiently sturdy to withstand the static and dynamic loads during the operation of a torsional vibration damper or of an uncoupled pulley. Moreover, it is easy to positively join the hub rim to the hub journal by screws without heating or deforming the hub rim or from the hub journal.

Before this backdrop, the a support device is, in an embodiment, configured as screw heads. More specifically, the elements that project like pins can be configured as screw heads. Owing to this concrete configuration, the screw heads can form a structure into which a hexagon wrench or a similar dolly block can fit positively. Advantageously, the screw heads that are available in a screwed connection anyway can be used to provide support against a torque.

It is likewise conceivable to use rivet heads or other head ends of fastening elements as supports.

The hub rim could be made of sheet metal and the hub journal could be made of a cast material. Owing to this concrete configuration, the hub rim can be manufactured separately from the hub journal. The hub rim can be inexpensively made of sheet metal, which can be deformed and geometrically shaped without any problem. Here, it is conceivable to shape the hub rim by means of deep-drawing processes. The hub journal can be made of a cast material and can be processed independently of the hub rim.

The inertia ring could be configured as a pulley. Owing to this concrete configuration, the device can drive auxiliary aggregates of a motor vehicle through the rotation of the crankshaft.

In addition to the inertia ring, a pulley could be provided that is connected to the hub journal via an additional elastomer. Thus, an uncoupled pulley can be created.

The additional elastomer could be connected on the one hand to the pulley and on the other hand to a pulley rim, whereby the pulley rim is joined to the hub journal by the support device. The pulley rim can be screwed without any problem to the hub journal, thereby coming to lie against the hub journal.

The device described here can be used as a torsional vibration damper or as an uncoupled pulley.

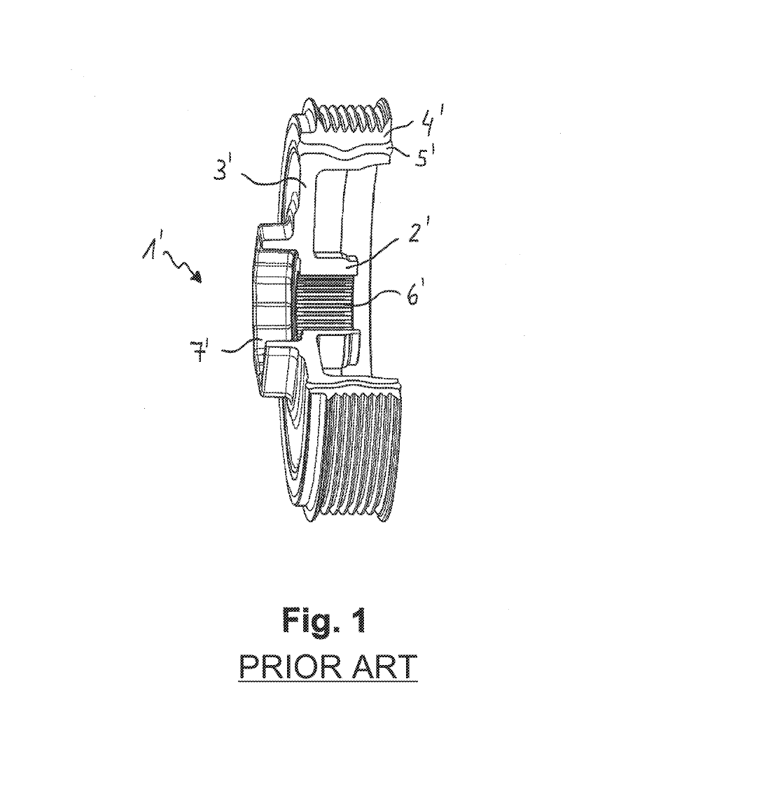

FIG. 1 shows a device, namely, a torsional vibration damper, to be arranged on a crankshaft, comprising a base 1′ with a hub journal 2′, a hub rim 3′ surrounding said hub journal 2′, and an inertia ring 4′, whereby the inertia ring 4′ is connected to the hub rim 3′ by means of an elastomer 5′ and encircles it, whereby the hub journal 2′ extends in the axial direction and has a. centered opening 6′ to receive a mounting screw, and whereby the hub rim 3′ or from the hub journal 2′ are fitted with means to provide support against a torque.

The means are configured as a socket 7′ whose inner and outer circumferential surfaces describe a hexagonal geometry. A dolly block with a hexagonal geometry can be inserted into the socket 7′ with a positive fit.

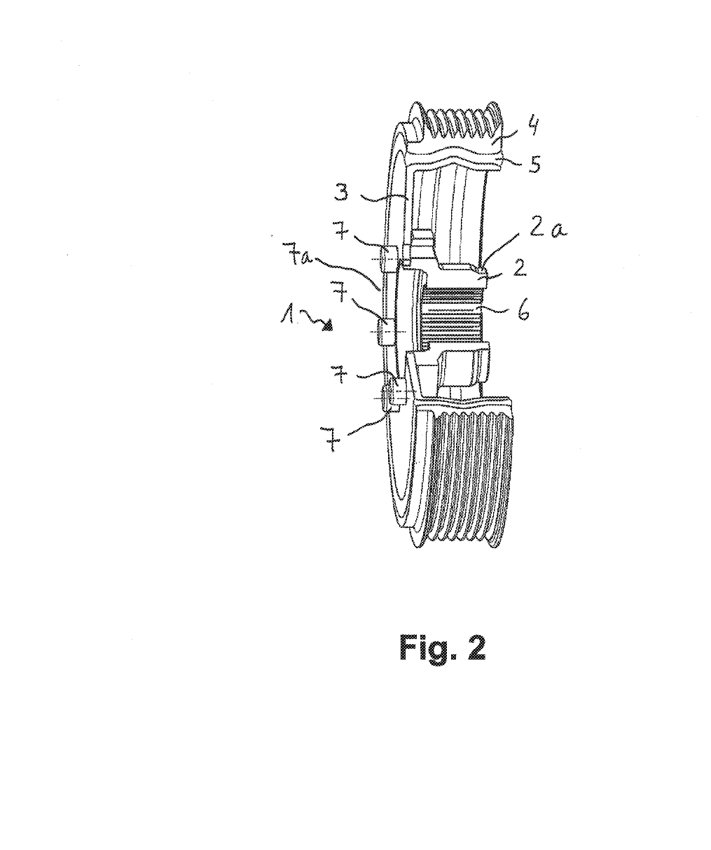

FIG. 2 shows a device, namely, a torsional vibration damper, according to an embodiment of the invention. FIG. 2 shows a torsional vibration damper to be arranged on a crankshaft, comprising a base 1 with a hub journal 2, a hub rim 3 surrounding said hub journal 2, and an inertia ring 4, whereby the inertia ring 4 is connected to the hub rim 3 by means of an elastomer 5 and encircles it, whereby the hub journal 2 extends in the axial direction and has a centered opening 6 to receive a mounting screw, and whereby the hub rim 3 or from the hub journal 2 are fitted with a support device to provide support against a torque.

The support device is configured as elements 7 that project like pins from the hub rim 3 or from the hub journal 2 in the axial direction.

The hub journal 2 has an elongated shape and extends in the axial direction. It has an outer circumferential surface 2a that serves as a sealing contact face for a sealing gasket. The hub journal 2 can be processed independently of the hub rim 3.

The elements 7 that project like pins form a circle or a crown, whereby distances 7a are configured between the individual elements 7 that project like pins. This concrete configuration allows a hexagon wrench or another polygon wrench to be inserted with a positive fit.

The hub journal 2 and the hub rim 3 are configured as separately produced parts. The hub journal 2 is screwed to the hub rim 3. The support device is configured as screw heads. More specifically, the elements 7 that project like pins are configured as screw heads.

The inertia ring 4 is configured as a pulley by means of which the auxiliary aggregates of a motor vehicle can be driven.

The huh rim 3 is made of sheet metal and the huh journal 2 is made of a cast material.

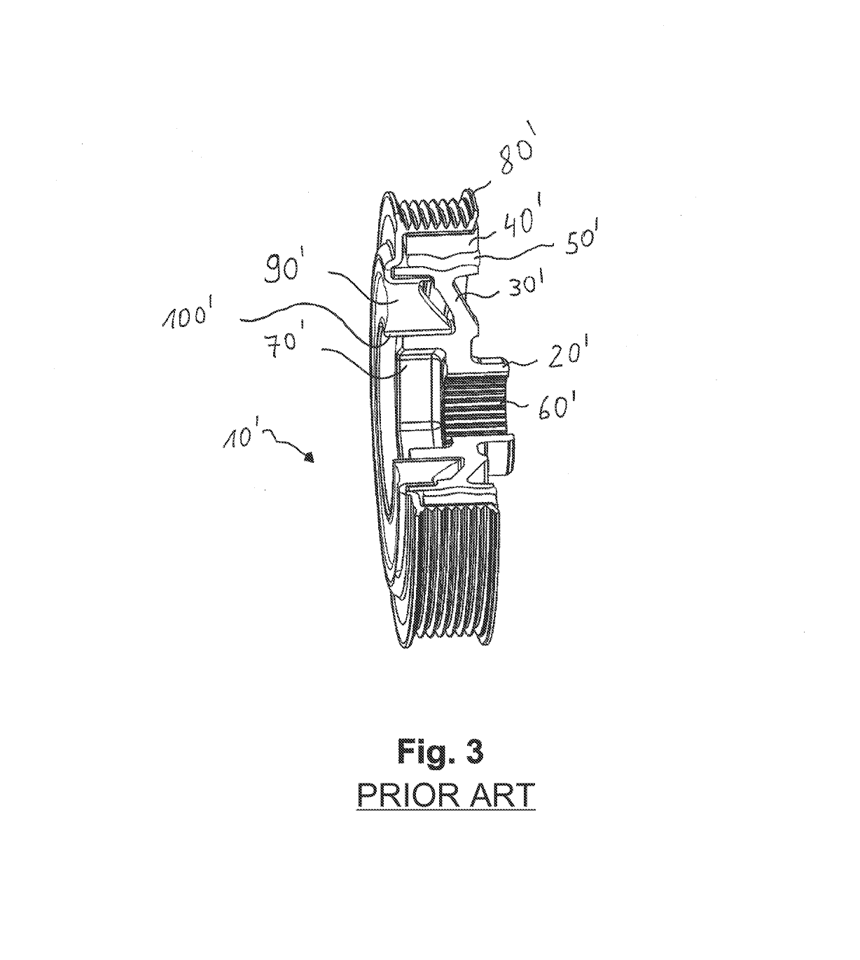

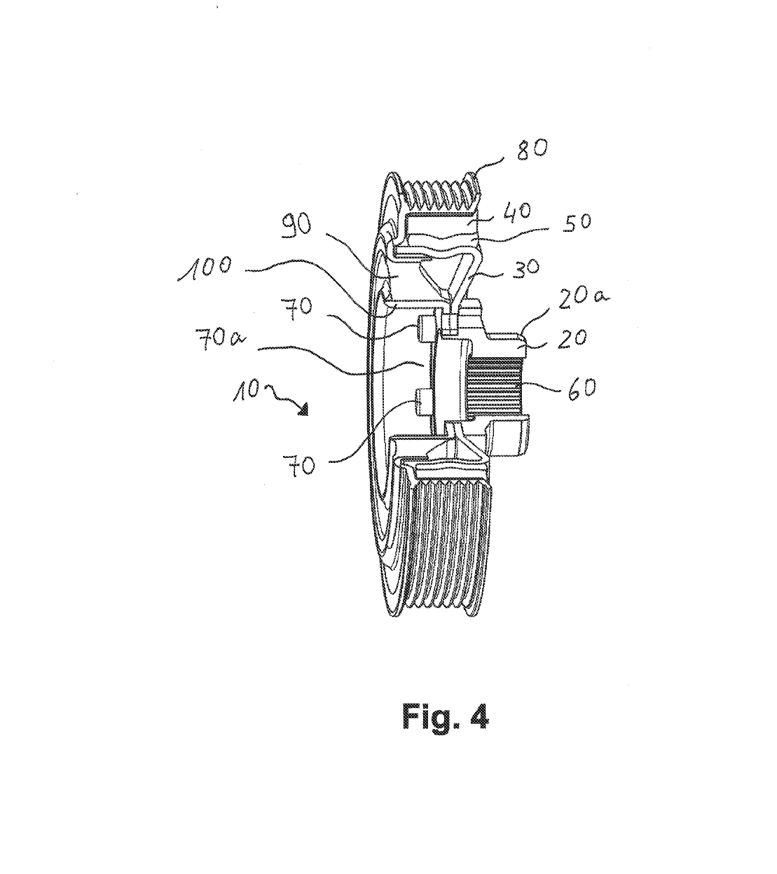

FIG. 3 shows an uncoupled pulley according to the state of the art. The device shown in FIG. 4 comprises a base 10′ with a hub journal 20′, a hub rim 30′ surrounding said hub journal 20, and an inertia ring 40′, whereby the inertia ring 40′ is connected to the hub rim 30′ by means of an elastomer 50′ and encircles it, whereby the hub journal 20′ extends in the axial direction and has a centered opening 60′ to receive a mounting screw, and whereby the hub rim 30′ or from the hub journal 20′ are fitted with means to provide support against a torque.

The means are configured as a socket 70′ whose inner and outer circumferential surfaces describe a hexagonal geometry. A dolly block with a hexagonal geometry can be inserted into the socket 70′ with a positive fit.

In addition to the inertia ring 40′, a pulley 80′ is provided that is connected to the hub journal 20′ via an additional elastomer 90′. The pulley 80′ is uncoupled from the inertia ring 40′ and surrounds it concentrically. The additional elastomer 90′ is connected on the one hand to the pulley 80′ and on the other hand to a pulley rim 100′, whereby the pulley rim 100′ is joined to the hub journal 20′.

FIG. 4 shows a device according to an embodiment of the invention. FIG. 4 shows an uncoupled pulley to be arranged on a crankshaft. The device comprises a base 10 with a hub journal 20, a hub rim 30 surrounding said huh journal 20, and an inertia ring 40, whereby the inertia ring 40 is connected to the hub rim 30 by means of an elastomer 50 and encircles it, whereby the hub journal 20 extends in the axial direction and has a centered opening 60 to receive a mounting screw, and whereby the hub rim 30 or from the hub journal 20 are fitted with a support device to provide support against a torque.

The support device is configured as elements 70 that project like pins from the hub rim 30 or from the hub journal 20 in the axial direction.

The huh journal 20 has an elongated shape and extends in the axial direction. It has an outer circumferential surface 20a that serves as a sealing contact face for a sealing gasket. The hub journal 20 can be processed independently of the hub rim 30.

The elements 70 that project like pins form a circle or a crown, whereby distances 70a are configured between the individual elements 70 that project like pins. This concrete configuration allows the positive fit of a hexagon wrench or of another polygon wrench.

The hub journal 20 and the hub rim 30 are configured as separately produced parts. The hub journal 20 is screwed to the hub rim 30. The support device is configured as screw heads. More specifically, the elements 70 that project like pins are configured as screw heads.

The hub rim 30 is made of sheet metal and the hub journal 20 is made of a cast material.

FIG. 4 shows a device according to an embodiment of the invention in which, in addition to the inertia ring 40, a pulley 80 is provided that is connected to the hub journal 20 via an additional elastomer 90. The pulley 80 is uncoupled from the inertia ring 40 and surrounds it concentrically.

The additional elastomer 90 is connected on the one hand to the pulley 80 and on the other hand to a pulley rim 100, whereby the pulley rim 100 is joined to the hub journal 20 by the support device, here using screwed means. Here, the pulley rim 100 lies against the hub rim 30.

The pulley rim 100 is made of sheet meta and the hub journal 20 is made of a cast material.

While the invention has been illustrated and described in detail in the drawings and foregoing description, such illustration and description are to be considered illustrative or exemplary and not restrictive. It will be understood that changes and modifications may be made by those of ordinary skill within the scope of the following claims, in particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

What is claimed is:

1. A device configured to be arranged on a crankshaft, comprising:
a base having a hub journal, the hub journal extending in an axial direction and having a centered opening configured to receive a mounting screw;
a hub rim surrounding the hub journal; and
an inertia ring encircling the hub rim and being connected to the hub rim via an elastomer,
wherein at least one of the hub rim and the hub journal is fitted with a support device configured to provide support against a torque, the support device including elements that project in a pin-like manner from the at least one of the hub rim and the hub journal in the axial direction.

2. The device according to claim 1, wherein the hub journal and the hub rim are separate parts manufactured separately from each other.

3. The device according to claim 1, wherein the hub journal (2, 20) is screwed to the hub rim.

4. The device according to claim 3, wherein the elements of the support device include screw heads.

5. The device according to claim 1, wherein the hub rim is made of sheet metal and the hub journal is made of a cast material.

6. The device according to claim 1, wherein the inertia ring is configured as a pulley.

7. The device according to claim 1, further comprising a pulley connected to the hub journal via an additional elastomer.

8. The device according to claim 7, further comprising a pulley rim joined to the hub journal by the support device, the additional elastomer being connected to the pulley and to the pulley rim.

9. The device according to claim 8, wherein the additional elastomer is connected to the pulley about an outer edge and to the pulley rim about an inner edge.

10. A method for torsional vibration dampling comprising:
providing a device configured to be arranged on a crankshaft, comprising:
a base having a hub journal, the hub journal extending in an axial direction and having a centered opening configured to receive a mounting screw;
a hub rim surrounding the hub journal; and
an inertia ring encircling the hub rim and being connected to the hub rim via an elastomer,
wherein at least one of the hub rim and the hub journal is fitted with a support device configured to provide support against a torque, the support device including elements that project in a pin-like manner from the at least one of the hub rim and the hub journal in the axial direction; and
using the device as a torsional vibration damper.

11. A method of using a pulley comprising:
providing a device configured to be arranged on a crankshaft, comprising:
a base having a hub journal, the hub journal extending in an axial direction and having a centered opening configured to receive a mounting screw;
a hub rim surrounding the hub journal;
an inertia ring encircling the hub rim and being connected to the hub rim via an elastomer; and
a pulley connected to the hub journal via an additional elastomer,
wherein at least one of the hub rim and the hub journal is fitted with a support device configured to provide support against a torque, the support device including elements that project in a pin-like manner from the at least one of the hub rim and the hub journal in the axial direction; and
using the device as an uncoupled pulley.
